(19) United States
(12) Patent Application Publication
(10) Pub. No.: US 2023/0264389 A1
(43) Pub. Date: Aug. 24, 2023

(54) SOLAR SILICON WAFER CUTTING METHOD, DEVICE, AND STORAGE MEDIUM

(71) Applicant: YINCHUAN LONGI PHOTOVOLTAIC TECHNOLOGY CO.,LTD., Yinchuan, Ningxia (CN)

(72) Inventors: Chengtian QI, Yinchuan, Ningxia (CN); Xiangyu LUO, Yinchuan, Ningxia (CN); Juanning ZHANG, Yinchuan, Ningxia (CN); Xudong CHEN, Yinchuan, Ningxia (CN); Shiyun WANG, Yinchuan, Ningxia (CN)

(21) Appl. No.: 18/013,342

(22) PCT Filed: Dec. 9, 2020
(86) PCT No.: PCT/CN2020/135022

§ 371 Date: Dec. 28, 2022

(30) Foreign Application Priority Data
Jun. 28, 2020 (CN) 202010600787.0

(51) Int. Cl. B28D 5/04; B28D 7/04; B28D 7/00

(52) U.S. Cl. CPC B28D 5/045; B28D 7/04; B28D 7/005

(57) ABSTRACT

The present disclosure provides a method and a device for cutting a solar silicon wafer, and a storage medium, which relate to the technical field of crystalline silicon cutting and can solve a problem of high labor intensity of operators caused by repeated operation in solar silicon wafer cutting, improve production efficiency and reduce misoperation. A technical solution is specifically as follows: loading materials to be cut to a section cutter (101); adjusting a cutting wire mesh according to preset requirements, starting a cutting procedure when cutting conditions are met, and cutting the materials to be cut (102); generating prompt information for completed cutting after the cutting is completed (103); and unloading cut materials from the section cutter according to the prompt information for the completed cutting (104). The present disclosure is used for silicon wafer cutting.

### CROSS-REFERENCES TO RELATED APPLICATIONS

The present disclosure claims the priority of the Chinese patent application filed on Jun. 28, 2020 before the CNIPA, China National Intellectual Property Administration with the application number of 202010600787.0 and the title of “SOLAR SILICON WAFER CUTTING METHOD, DEVICE, AND STORAGE MEDIUM”, which is incorporated herein in its entirety by reference.

### TECHNICAL FIELD

The disclosure relates to the technical field of crystalline silicon cutting and, more particularly, to a method and a device for cutting a solar silicon wafer, and to a storage medium.

### BACKGROUND

In an existing process of solar silicon wafer processing, each cutting process of materials needs to involve 16 steps, such as loading of materials, adjusting of a wire mesh, flushing of loaded materials, discharging of waste liquid in cutting, cleaning of a mortar tank, adding of water, adding of cutting liquid, paying off of wires, machine heating, confirming whether jumping (In multi-wire cutting, the wire mesh is disposed between two guide rollers with grooves. Normally, the wires are in the grooves. Jumping refers to that the wires are out of the grooves) occurs, knife aligning, cutting, cutting-through confirmation, cleaning before unloaded materials, material lifting, cleaning of mortar pipes, etc. Each step requires operation by an operator, and high-frequency actions may easily damage operator's body, causing the operator to feel tired, affecting physical and mental health of employees and seriously affecting production efficiency and misoperation in the cutting process. It is a common problem in the cutting industry to effectively improve production efficiency, reduce misoperation and reduce repeated labor intensity of employees, which is urgent to be improved.

### SUMMARY

The embodiment of the present disclosure provides a method and a device for cutting a solar silicon wafer, and a storage medium, which can solve a problem of high labor intensity of operators caused by repeated operation in solar silicon wafer cutting, improve production efficiency and reduce misoperation. Technical solution is as follows.

According to a first aspect of an embodiment of the present disclosure, there is provided a method of cutting a solar silicon wafer, which includes:

loading materials to be cut to a section cutter;

adjusting a cutting wire mesh according to preset requirements, starting a cutting procedure when cutting conditions are met, and cutting the materials to be cut;

generating prompt information for completed cutting after the cutting is complete; and

unloading cut materials from the section cutter according to the prompt information for completed cutting.

In this embodiment, cutting steps are optimized so that automatic processing of material loading, cutting and unloading can be realized, material cutting efficiency is improved, and labor intensity and misoperation of operators are reduced.

In an embodiment, the cutting procedure comprises a cutting preparation procedure and a cutting processing procedure; starting the cutting procedure when the cutting conditions are met and cutting the materials to be cut comprises:

starting and executing the cutting preparation procedure when the cutting conditions are met;

detecting whether there is jumping in the cutting wire mesh when the cutting preparation procedure is completed; and

executing the cutting processing procedure to cut the materials to be cut when there is no jumping in the cutting wire mesh.

In an embodiment, the method further comprising:

detecting whether the materials to be cut are cut through when execution of the cutting processing procedure is completed; and

when the materials to be cut are not cut through, executing the cutting processing procedure again until the materials to be cut are cut through.

In an embodiment, generating the prompt information for completed cutting after the cutting is completed comprises:

generating the prompt information for completed cutting when the materials to be cut are cut through.

In an embodiment, the method further comprising:

generating jumping prompt information and handling the jumping when there is jumping in the cutting wire mesh.

In an embodiment, starting the cutting procedure when the cutting conditions are met comprises:

obtaining a user operation instruction when the cutting conditions are met; and

starting the cutting procedure according to the user operation instruction.

In an embodiment, unloading the cut materials from the section cutter according to the prompt information for completed cutting comprises:

executing an unloading preparation procedure according to the prompt information for the completed cutting; and

manually or mechanically unloading the cut materials from the section cutter when execution of the unloading preparation procedure is completed.

In an embodiment, loading the materials to be cut to the section cutter comprises:

loading the materials to be cut to the section cutter manually or mechanically.

According to a second aspect of an embodiment of the present disclosure, there is provided a device for cutting a solar silicon wafer, which includes a processor and a memory with at least one computer instruction stored therein, and the instruction is loaded and executed by the processor to implement steps performed in the methods for cutting the solar silicon wafer described in the first aspect and any of embodiments of the first aspect.

According to a fourth aspect of an embodiment of the present disclosure, there is provided a computer readable storage medium with at least one computer instruction stored therein, and the instruction is loaded and executed by the processor to implement steps performed in the methods for cutting the solar silicon wafer described in the first aspect and any of embodiments of the first aspect.

It should be understood that above general description and following detailed description are exemplary and explanatory only, and do not limit the present disclosure.

The above description is only a summary of technical schemes of the present disclosure, which can be implemented according to contents of the specification in order to better understand technical means of the present disclosure; and in order to make above and other objects, features and advantages of the present disclosure more obvious and understandable, detailed description of the present disclosure is particularly provided in the following.

### BRIEF DESCRIPTION OF THE DRAWINGS

In order to explain embodiments of the present disclosure or the technical scheme in the prior art more clearly, the drawings required in the description of the embodiments or the prior art will be briefly introduced below; obviously, the drawings in the following description are some embodiments of the present disclosure, and other drawings can be obtained according to these drawings by those of ordinary skill in the art without paying creative labor.

The drawings herein are incorporated into and constitute a part of the specification, illustrate embodiments consistent with the disclosure, and together with the specification, serve to explain principles of the disclosure.

FIG. 1 is a flow chart of a method for cutting a solar silicon wafer according to an embodiment of the present disclosure;

FIG. 2 is a flow chart of a method for cutting a solar silicon wafer according to an embodiment of the present disclosure;

FIG. 3 is a schematic structural diagram of a device for cutting a solar silicon wafer according to an embodiment of the present disclosure;

FIG. 4 is a schematic structural diagram of a device for cutting a solar silicon wafer according to an embodiment of the present disclosure;

FIG. 5 schematically shows a block diagram of a computing processing device for executing the method according to the present disclosure; and

FIG. 6 schematically shows a storage unit for holding or carrying program codes for implementing the method according to the present disclosure.

### DETAILED DESCRIPTION OF THE EMBODIMENTS

In order to make purposes, technical schemes and advantages of embodiments of this disclosure more clear, the technical schemes in the embodiments of this disclosure will be described clearly and completely with reference to the drawings in the embodiments of this disclosure; and it is obvious that the described embodiments are part of the embodiments of this disclosure, but not all of them. On a basis of the embodiments in this disclosure, all other embodiments obtained by the ordinary skilled in the art without paying creative effort are within a protection scope of this disclosure.

Here, exemplary embodiments will be described in detail, examples of which are shown in the accompanying drawings. When the following description refers to the drawings, a same number in different drawings indicates a same or similar elements, unless otherwise indicated. The embodiments described in the following exemplary embodiments do not represent all of the embodiments consistent with this disclosure. On the contrary, they are only examples of devices and methods consistent with some of aspects of the present disclosure as detailed in the appended claims.

Before introducing the embodiments of the present disclosure, the technology related to this embodiment will be described firstly.

Multi-wire cutting technology of silicon wafers is an advanced silicon wafer processing technology in the world at present, with a principle that a high-speed moving steel wire drives a cutting edge material attached to the steel wire to rub a silicon rod, so as to achieve cutting effect. In an actual cutting process of a crystalline silicon rod, the steel wire is guided by more than a dozen of wire guide wheels, so as to form a wire mesh on cutting rollers on opposite sides of a worktable. A workpiece to be processed is fed by ascending and descending of the worktable, and the workpiece to be processed can be cut into many slices at the same time. The cutting wire is evenly wound on a cylindrical wire storage barrel, and a reciprocating wiring system is formed by a wiring mechanisms such as a wire guide wheel and a cutting roller. The cutting wire is guided and wound into a ready-to-use wiring groove of the cutting roller by the wire guide wheel, so that the cutting wire does not deviate during wiring. However, in an actual process of cutting the workpiece, due to precision of the wire guide wheel, rigidity of a wire frame and non-uniform tension of the cutting wire on the wire storage barrel, as well as constant shaking of the cutting wire during high-speed wiring, a wiring process being a sawing reciprocating motion, and impurities (such as broken wafers and impurities in mortar) entering the wire groove or being adhered to the wire mesh, etc., it is easy for the cutting wire to jump out, resulting in deviation of the wiring, that is, the jumping. Specifically, the cutting wire jumps from an original ready-to-use wiring groove to a next spare wiring groove, the cutting wire deviates from its original position, which leads to phenomenon of jumping.

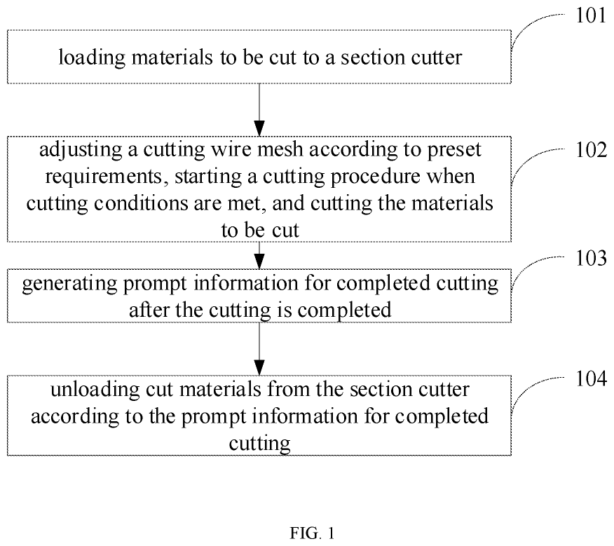

The embodiment of the present disclosure provides a method for cutting a solar silicon wafer, as shown in FIG. 1, which includes following steps S101 to S104.

In step 101, materials to be cut are loaded to a section cutter.

In the embodiment of the present disclosure, loading the materials to be cut to the section cutter includes loading the materials to be cut to the section cutter manually or mechanically.

In step 102, a cutting wire mesh is adjusted according to preset requirements, a cutting procedure is started when cutting conditions are met, and the materials to be cut are cut.

After loading, the wire mesh is adjusted according to the preset cutting requirements, and the cutting procedure is started when the cutting conditions are met. Specifically, when the cutting conditions are met, a user operation instruction is obtained. The cutting procedure is started according to the user operation instruction. Exemplary, when mesh adjustment meets the cutting conditions, the user clicks a mesh-adjustment ok button, and at this time, the cutting procedure is started.

In an embodiment of the present disclosure, the cutting procedure includes at least a cutting preparation procedure and a cutting processing procedure. Then, starting the cutting procedure when the cutting conditions are met, cutting the materials to be cut includes:

starting and executing the cutting preparation procedure when the cutting conditions are met;

detecting whether there is jumping in the cutting wire mesh when the cutting preparation procedure is completed; and

executing the cutting processing procedure to cut the materials to be cut when there is no jumping in the cutting wire mesh.

The cutting preparation procedure is configured to prepare for cutting. The cutting preparation procedure at least involves cleaning a chamber, liquid discharging, cleaning the mortar tank, adding liquid (including adding water and cutting liquid), paying off wires, heating the machine, etc. All of steps in the cutting preparation procedure are automatically performed. After execution of the cutting preparation procedure is completed, it is possible to detect whether there is jumping in the cutting wire mesh at a preset time interval (such as 10 seconds). When there is no jumping in the cutting wire mesh, the cutting processing procedure is executed to cut the materials to be cut, and the cutting processing procedure involves knife aligning and cutting.

Further, after execution of the cutting processing procedure is completed, it is detected whether the materials to be cut are cut through. When the materials to be cut are not cut through, the cutting processing procedure is executed again until the materials to be cut are cut through. It indicates that the cutting is complete only when the materials to be cut are cut through.

When there is jumping in the cutting wire mesh, jumping prompt information is generated and a jumping problem is handled. The jumping prompt information can be alarm prompt, voice prompt and signal-light prompt. The jumping prompt information is used to remind operators of the jumping problem. When receiving the jumping prompt information, the operators can check causes of the jumping problem and make repairs. Of course, when it is detected that there is jumping in the cutting wire mesh, and the causes of the jumping can be obtained while the jumping prompt information is generated, and the jumping problem can be automatically solved according to the causes of the jumping.

In step 103, prompt information for completed cutting is generated after the cutting is completed.

In an embodiment of the present disclosure, the prompt information for completed cutting may be alarm information, sound information, signal light prompt, etc. Prompt information in the cutting technology is used to indicate that the materials to be cut has been cut and needs to be unloaded from the section cutter.

In the step 104, cut materials is unloaded from the section cutter according to the prompt information for completed cutting.

Specifically, unloading the cut materials from the section cutter according to the prompt information for the completed cutting includes:

executing an unloading preparation procedure according to the prompt information for the completed cutting; and

unloading the cut materials from the section cutter when execution of the unloading preparation procedure is completed.

The unloading preparation procedure at least involves flushing of unloaded materials, material lifting, liquid discharging, cleaning of a mortar pipe, etc. All of steps in the unloading preparation procedure are performed by automated programs. When execution of the unloading preparation procedure is completed, the cut materials are manually or mechanically unloaded from the section cutter.

The method for cutting the solar silicon wafer according to the embodiment of the present disclosure includes following steps: loading the materials to be cut to the section cutter; adjusting the cutting wire mesh according to preset requirements, starting the cutting procedure when the cutting conditions are met, and cutting the materials to be cut; generating the prompt information for the completed cutting after the cutting is completed; and unloading cut materials from the section cutter according to the prompt information for the completed cutting. In this embodiment, the cutting steps are optimized so that automatic processing of material loading, cutting and unloading can be realized, material cutting efficiency is improved, and labor intensity and misoperation of operators are reduced.

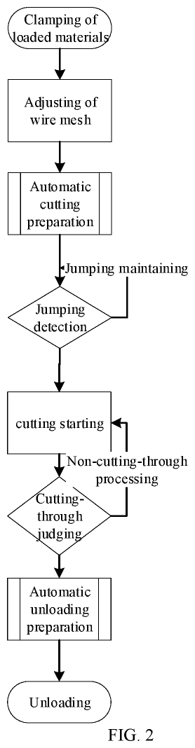

Based on the method for cutting the solar silicon wafer according to an embodiment corresponding to FIG. 1, a method for cutting a solar silicon wafer is provided in another embodiment of the present disclosure. Referring to FIG. 2, the method for cutting the solar silicon wafer according to this embodiment includes following steps.

In step 1, materials to be cut are loaded manually or mechanically, that is, the materials to be cut are loaded into a section cutter.

In step 2, a wire mesh is adjusted, and a mesh-adjustment OK button is clicked after the cutting conditions are met.

In step 3, after a cutting operation (including cleaning, paying off, heating machine, adding liquid and cutting, and also involving jumping detection and confirmation and cutting-through confirmation) is completed by a device automatically, an alarm is fed back for ending of the cutting.

Specifically, after the mesh-adjustment OK button is clicked, the cutting preparation procedure is executed, that is, automatic cutting preparation is carried out, including cleaning a chamber, discharging liquid, cleaning the mortar tank, adding liquid (adding water and cutting liquid), paying off wires, heating the machine, etc. After the cutting preparation is completed, it is detected whether jumping exists. If there is jumping, the jumping is processed until there is no jumping; and if there is no jumping, the materials to be cut are cut and cutting-through judgment is performed, that is, it is detected whether the materials to be cut are cut through. If the materials to be cut are not cut through, the materials to be cut are cut again until they are cut through. After the materials to be cut are cut through, the alarm is fed back for ending of the cutting.

In step 4: after unloading preparation operation is completed by the device, the materials are unloaded (from the section cutter) manually or mechanically.

Specifically, after the cutting is completed, the unloading preparation operation can be carried out automatically, including flushing of unloaded materials, material lifting, liquid discharging, cleaning of a mortar pipe, etc. After the unloading preparation operation is completed, the cut materials may be unloaded from the section cutter manually or mechanically.

The method for cutting the solar silicon wafer according to the embodiment of the present disclosure can solve manual waste caused by repeated operations of solar silicon wafers, and avoid a physical and mental health problem of personnel caused by repeated strong labor, thereby decreasing reciprocating action of employees, reducing labor fatigue and misoperation, and further achieving actual production efficiency improvement. Taking cutting steps with personnel involving being decreased from original 16 steps to 4 steps (wire mesh adjustment, jumping detection, cutting starting, cutting-through judgment) and other steps being performed automatically as an example, it can be realized that time each cutting on site takes is reduced from original 25 min to 7 min, with labor intensity being greatly reduced by 72% and production efficiency increased by 17%.

In this embodiment, with optimization of cutting steps, a process flow from material loading to completed cutting can be realized by clicking one button to start. Material cutting is realized by a one-button start-up system, and meanwhile, in a one-button cutting process, cutting is prepared automatically and unloading is prepared automatically Aiming at the solar silicon wafer processing industry, this embodiment uses a one-key start-up method to achieve fast cutting, which presents a fast operation function for the slicing steps in a silicon wafer processing process, thereby improving material cutting efficiency and reducing labor intensity and misoperation of the employees.

Based on the method for cutting the solar silicon wafer described in the embodiments corresponding to FIGS. 1 and 3, a device embodiment of the present disclosure is described in the following, which can be used to implement a method embodiment of the present disclosure.

A device for cutting a solar silicon wafer is provided in an embodiment of the present disclosure. As shown in FIG. 3, the device 30 for cutting the solar silicon wafer includes a loading module 301, an adjusting module 302, a cutting module 303, a generating module 304 and an unloading module 305.

The loading module 301 is configured to load materials to be cut to the section cutter.

The adjusting module 302 is configured to adjust a cutting wire mesh according to preset requirements.

The cutting module 303 is configured to start a cutting procedure when cutting conditions are met, and to cut the materials to be cut.

The generating module 304 is configured to prompt information for completed cutting after the cutting is complete

The unloading module 305 is configured to unload cut materials from the section cutter according to the prompt information for completed cutting.

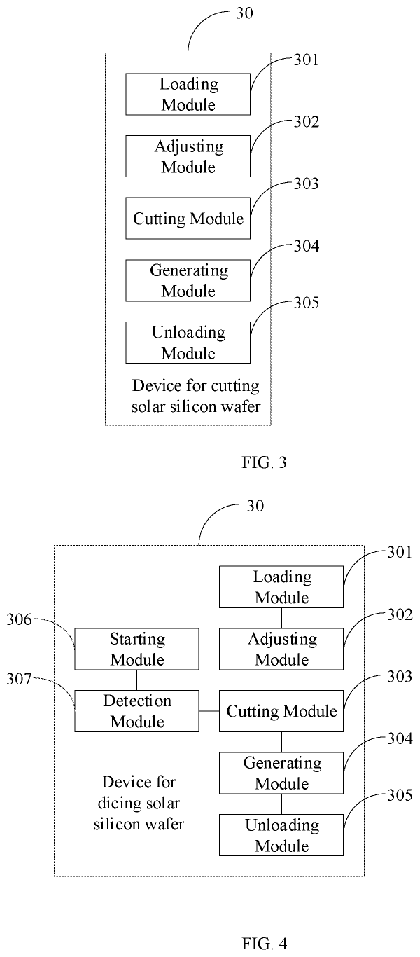

In an embodiment, the cutting procedure includes a cutting preparation procedure and a cutting processing procedure. As shown in FIG. 4, the device 30 for cutting the solar silicon wafer further includes a starting module 306, a detection module 307 and a cutting module 303.

The starting module 306 is configured to start and execute the cutting preparation procedure when the cutting conditions are met.

The detection module 307 is configured to detect whether there is jumping in the cutting wire mesh when the cutting preparation procedure is completed.

The cutting module 303 is configured to execute the cutting processing procedure to cut the materials to be cut when there is no jumping in the cutting wire mesh.

In an embodiment, the detection module 307 is configured to detect whether the materials to be cut are cut through when execution of the cutting processing procedure is completed.

The cutting module 303 is configured to, when the materials to be cut are not cut through, execute the cutting processing procedure again until the materials to be cut are cut through.

In an embodiment, the generating module 304 is configured to generate the prompt information for completed cutting when the materials to be cut are cut through.

In an embodiment, the generating module 304 is configured to generate jumping prompt information and handle the jumping when there is jumping in the cutting wire mesh.

In an embodiment, the starting module 306 is configured to obtain a user operation instruction when the cutting conditions are met; and to start the cutting procedure according to the user operation instruction.

In an embodiment, the unloading module 305 is configured to execute an unloading preparation procedure according to the prompt information for completed cutting; and to manually or mechanically unload the cut materials from the section cutter when execution of the unloading preparation procedure is completed.

In an embodiment, the loading module 301 is configured to load the materials to be cut to the section cutter manually or mechanically.

The method for cutting the solar silicon wafer according to the embodiment of this disclosure includes following steps: loading the materials to be cut to the section cutter; adjusting the cutting wire mesh according to preset requirements, starting the cutting procedure when the cutting conditions are met, and cutting the materials to be cut; generating the prompt information for the completed cutting after the cutting is complete; and unloading cut materials from the section cutter according to the prompt information for the completed cutting. In this embodiment, the cutting is optimized so that automatic processing of material loading, cutting and unloading can be realized, material cutting efficiency is improved, and labor intensity and misoperation of operators are reduced.

A device for cutting a solar silicon wafer is further provided in an embodiment of the disclosure, which includes a receiver, a transmitter, a memory and a processor. The transmitter and the memory are respectively connected with the processor, and at least one computer instruction is stored in the memory, and the processor is configured for loading and executing the at least one computer instruction, so as to realize the method for cutting a solar silicon wafer described in the embodiment corresponding to FIG. 1 above.

Based on the method for cutting the solar silicon wafer described in embodiments corresponding to FIGS. 1 and 2, a computer-readable storage medium is further provided in embodiments of the present disclosure, for example, the non-temporary computer-readable storage medium may be a Read Only Memory (ROM), a Random Access Memory (RAM), CD-ROM, a magnetic tape, a floppy disk, an optical data storage device, etc. The storage medium has computer instructions stored thereon, which are configured to execute the method for cutting the solar silicon wafer described in the embodiments corresponding to FIGS. 1 and 2, which will not be repeatedly described here again.

It can be understood by those skilled in the art that all or part of the steps to realize above embodiments can be completed by hardware, or by related hardware instructed by programs, which can be stored in a computer-readable storage medium, the computer-readable storage medium can be a read-only memory, a magnetic disk or an optical disk.

Other embodiments of the present disclosure will readily occur to those skilled in the art with considering the specification and practicing the disclosure provided herein. This disclosure is intended to cover any variations, uses or adaptations of this disclosure, which follow general principles of this disclosure and include common knowledge or customary practice in the art not provided in this disclosure. The specification and embodiments are regarded to be exemplary only, and a true scope and spirit of the present disclosure are indicated by following claims.

The above-described apparatus embodiments are only schematic, in which units described as separate components may or may not be physically separated, and the components shown as the units may or may not be physical units, that is, they may be located in one place or distributed over multiple network units. Some or all of the modules can be selected according to actual needs to achieve purposes of this embodiment. The embodiments can be understood and implemented by the ordinary skilled in the art without paying creative labor.

Various component embodiments disclosed herein can be implemented in hardware, or in software modules executed on one or more processors, or in a combination thereof. It should be understood by those skilled in the art that some or all of functions of some or all of the components in the computing processing device according to the embodiments of the present disclosure can be realized in practice by using a microprocessor or a digital signal processor (DSP). The present disclosure can also be implemented as device or apparatus programs (e.g., computer programs and computer program products) for performing part or all of the methods described herein. Such programs for realizing the present disclosure may be stored on a computer readable medium, or may be in a form of one or more signals. Such signals can be downloaded from Internet websites, or provided on carrier signals, or provided in any other form.

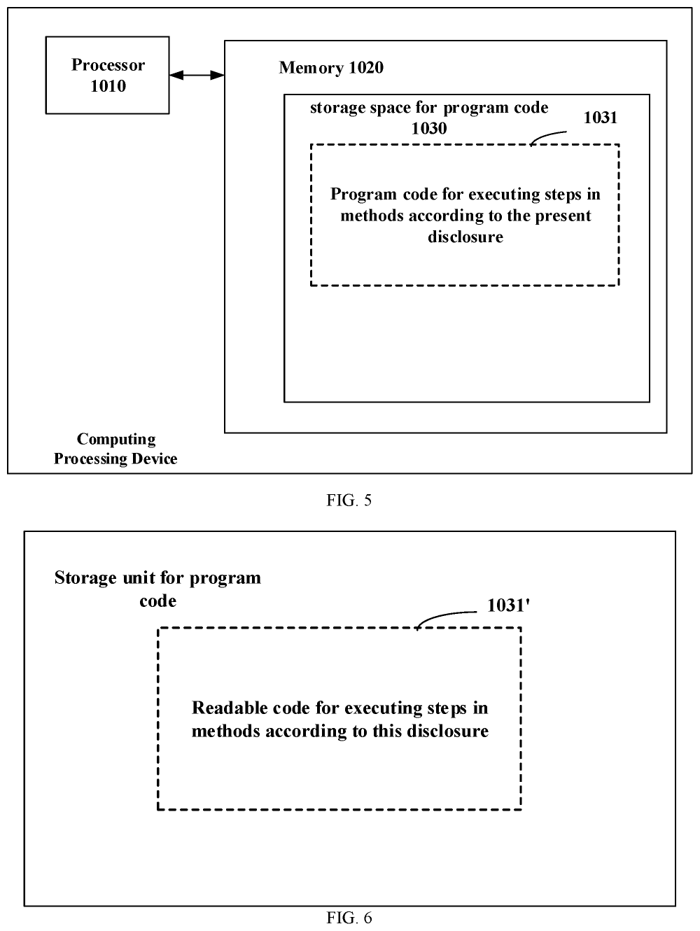

For example, FIG. 5 shows a computing processing device that can implement the methods according to the present disclosure. The computing processing device conventionally includes a processor 1010 and a computer program product or a computer readable medium in a form of a memory 1020. The memory 1020 may be an electronic memory such as a flash memory, an EEPROM (electrically erasable programmable read only memory), an EPROM, a hard disk or a ROM. The memory 1020 has a storage space 1030 for program codes 1031 for executing any of steps in the above methods. For example, the storage space 1030 for program codes may include various program codes 1031 for implementing various steps in the above method, respectively. These program codes can be read from or written into one or more computer program products. These computer program products include program code carriers such as hard disks, compact disks (CD), memory cards or floppy disks. Such computer program products are usually portable or fixed storage units as described with reference to FIG. 6. The memory unit may have memory segments, memory spaces, and the like arranged similarly to the memory 1020 in the computing processing device of FIG. 5. The program can be compressed in an appropriate form, for example. Generally, the storage unit includes computer readable codes 1031′, i.e., codes that can be read by, for example, a processor such as 1010, which, when executed by a computing processing device, causes the computing processing device to perform various steps in the methods described above.

Reference to “one embodiment”, “an embodiment” or “one or more embodiments” herein means that a specific feature, structure or characteristic described in connection with embodiments is included in at least one embodiment of the present disclosure. In addition, it is noted that an example of a word “in one embodiment” here do not necessarily refer to a same embodiment.

In the specification provided here, numerous specific details are set forth. However, it can be understood that the embodiments of the present disclosure can be practiced without these specific details. In some instances, well-known methods, structures and techniques have not been shown in detail in order not to obscure understanding of this specification.

In the claims, any reference signs between parentheses shall not be construed as limitations on the claims. A word “comprising” does not exclude presence of elements or steps not listed in a claim. A word “a” or “an” preceding an element does not exclude presence of a plurality of such elements. The present disclosure can be realized by means of hardware including several different elements and by means of a suitably programmed computer. In a unit claim enumerating several devices, several of these devices can be embodied by a same item of hardware. Use of words “first”, “second”, “third”, etc. does not indicate any order. These words can be interpreted as names.

Finally, it should be noted that the above embodiments are only intended to illustrate technical schemes of the present disclosure, but not to limit it. Although the present disclosure has been described in detail with reference to the foregoing embodiments, it should be understood by ordinary skilled in the art that modifications can be made to the technical schemes described in the foregoing embodiments, or equivalent substitutions can be made to some technical features thereof. These modifications or substitutions do not make essence of corresponding technical schemes depart from the spirit and scope of the technical schemes of the embodiments of this disclosure.

1. A method for cutting a solar silicon wafer, comprising:
loading materials to be cut to a section cutter;
adjusting a cutting wire mesh according to preset requirements, starting a cutting procedure when cutting conditions are met, and cutting the materials to be cut;
generating prompt information for completed cutting after the cutting is completed; and
unloading cut materials from the section cutter according to the prompt information for completed cutting.

2. The method according to claim 1, wherein the cutting procedure comprises a cutting preparation procedure and a cutting processing procedure; starting the cutting procedure when the cutting conditions are met and cutting the materials to be cut comprises:
starting and executing the cutting preparation procedure when the cutting conditions are met;
detecting whether there is jumping in the cutting wire mesh when the cutting preparation procedure is completed; and
executing the cutting processing procedure to cut the materials to be cut when there is no jumping in the cutting wire mesh.

3. The method according to claim 2, further comprising:
detecting whether the materials to be cut are cut through when execution of the cutting processing procedure is completed; and
when the materials to be cut are not cut through, executing the cutting processing procedure again until the materials to be cut are cut through.

4. The method according to claim 3, wherein generating the prompt information for completed cutting after the cutting is completed comprises:
generating the prompt information for completed cutting when the materials to be cut are cut through.

5. The method according to claim 2, further comprising:
generating jumping prompt information and handling the jumping when there is jumping in the cutting wire mesh.

6. The method according to claim 1, wherein starting the cutting procedure when the cutting conditions are met comprises:
obtaining a user operation instruction when the cutting conditions are met; and
starting the cutting procedure according to the user operation instruction.

7. The method according to claim 1, wherein unloading the cut materials from the section cutter according to the prompt information for completed cutting comprises:
executing an unloading preparation procedure according to the prompt information for the completed cutting; and
manually or mechanically unloading the cut materials from the section cutter when execution of the unloading preparation procedure is completed.

8. The method according to claim 1, wherein loading the materials to be cut to the section cutter comprises:
loading the materials to be cut to the section cutter manually or mechanically.

9. A device for cutting a solar silicon wafer, comprising a processor and a memory, wherein at least one computer instruction is stored in the memory, and the instruction is loaded and executed by the processor to implement steps performed in the method for cutting the solar silicon wafer according to claim 1.

10. A computer-readable storage medium, wherein at least one computer instruction is stored in the storage medium, and the instruction is loaded and executed by the processor to implement steps performed in the method for cutting the solar silicon wafer according to claim 1.

11-13. (canceled)

14. The device according to claim 9, wherein the cutting procedure comprises a cutting preparation procedure and a cutting processing procedure; starting the cutting procedure when the cutting conditions are met and cutting the materials to be cut comprises:
starting and executing the cutting preparation procedure when the cutting conditions are met;
detecting whether there is jumping in the cutting wire mesh when the cutting preparation procedure is completed; and
executing the cutting processing procedure to cut the materials to be cut when there is no jumping in the cutting wire mesh.

15. The device according to claim 14, further comprising:
detecting whether the materials to be cut are cut through when execution of the cutting processing procedure is completed; and
when the materials to be cut are not cut through, executing the cutting processing procedure again until the materials to be cut are cut through.

16. The device according to claim 15, wherein generating the prompt information for completed cutting after the cutting is completed comprises:
generating the prompt information for completed cutting when the materials to be cut are cut through.

17. The device according to claim 14, further comprising:
generating jumping prompt information and handling the jumping when there is jumping in the cutting wire mesh.

18. The device according to claim 9, wherein starting the cutting procedure when the cutting conditions are met comprises:
obtaining a user operation instruction when the cutting conditions are met; and
starting the cutting procedure according to the user operation instruction.

19. The device according to claim 9, wherein unloading the cut materials from the section cutter according to the prompt information for completed cutting comprises:
executing an unloading preparation procedure according to the prompt information for the completed cutting; and
manually or mechanically unloading the cut materials from the section cutter when execution of the unloading preparation procedure is completed.

20. The device according to claim 9, wherein loading the materials to be cut to the section cutter comprises:
loading the materials to be cut to the section cutter manually or mechanically.

21. The device according to claim 10, wherein the cutting procedure comprises a cutting preparation procedure and a cutting processing procedure; starting the cutting procedure when the cutting conditions are met and cutting the materials to be cut comprises:
starting and executing the cutting preparation procedure when the cutting conditions are met;
detecting whether there is jumping in the cutting wire mesh when the cutting preparation procedure is completed; and
executing the cutting processing procedure to cut the materials to be cut when there is no jumping in the cutting wire mesh.

22. The device according to claim 21, further comprising:
detecting whether the materials to be cut are cut through when execution of the cutting processing procedure is completed; and
when the materials to be cut are not cut through, executing the cutting processing procedure again until the materials to be cut are cut through.

23. The device according to claim 22, wherein generating the prompt information for completed cutting after the cutting is completed comprises:
generating the prompt information for completed cutting when the materials to be cut are cut through.
